(19) United States
(12) Patent Application Publication
(10) Pub. No.: US 2015/0212395 A1
(43) Pub. Date: Jul. 30, 2015

(54) IMAGING APPARATUS AND IMAGING SYSTEM

(71) Applicant: SONY CORPORATION, Tokyo (JP)

(72) Inventors: SHIN KURODA, KANAGAWA (JP); KATSUYA FUJII, TOKYO (JP); SATOSHI MORIYAMA, KANAGAWA (JP)

(21) Appl. No.: 14/600,438

(22) Filed: Jan. 20, 2015

(30) Foreign Application Priority Data
Jan. 30, 2014 (JP) 2014015451

(51) Int. Cl. G03B 17/14; G03B 17/56

(52) U.S. Cl. CPC G03B 17/14; G03B 17/566

(57) ABSTRACT

An imaging apparatus includes: a body; and a body mount of a spigot type that is provided on the body. The body mount includes a fixing ring, and a rotation ring that is rotatable around an optical axis relative to the fixing ring and has a notch portion on a part of a circumference.

### CROSS REFERENCE TO RELATED APPLICATIONS

This application claims the benefit of Japanese Priority Patent Application JP 2014-015451 filed Jan. 30, 2014, the entire contents of which are incorporated herein by reference.

### BACKGROUND

The present disclosure relates to an imaging apparatus such as an interchangeable lens camera, and an imaging system including the imaging apparatus.

In interchangeable lens cameras, a body mount is provided on a body, and an opening, which is called a lens mount, is provided on a lens. Thus, by combining both of those, the lens is mounted on the body. One of the methods of combining the body mount and the lens mount is a spigot method. In the spigot method, a target object such as a lens or an adapter, which is intended to be mounted, is inserted into the opening of the body mount, and the target object is fastened to be fixed by turning a ring (rotation ring) provided on the body mount (for example, refer to Japanese Unexamined Patent Application Publication No. 8-220617).

### SUMMARY

The lens or adapter typically has a main body having a cylindrical shape, but there may be provided a protruding component that protrudes outward from the main body in a diameter direction with respect to the optical axis. In such a lens or such an adapter, interference between the protruding component and the rotation ring of the body mount is likely to occur.

According to the present disclosure, it is desirable to provide an imaging apparatus, which is capable of avoiding interference between the protruding component and the rotation ring of the body mount of the lens or the adapter, and an imaging system having the imaging apparatus.

According to a first embodiment of the present disclosure, there is provided an imaging apparatus including: a body; and a body mount of a spigot type that is provided on the body, in which the body mount includes a fixing ring, and a rotation ring that is rotatable around an optical axis relative to the fixing ring and has a notch portion on a part of a circumference.

According to a second embodiment of the present disclosure, there is provided an imaging system including: the imaging apparatus according to the first embodiment of the present disclosure; and a lens which is mountable on the imaging apparatus.

In the imaging apparatus according to the first embodiment of the present disclosure or the imaging system according to the second embodiment of the present disclosure, a notch portion is provided on a part of a circumference of the rotation ring of the body mount. Therefore, interference between the rotation ring of the body mount and the protruding component, which protrudes outward from the lens or the adapter in the diameter direction with respect to the optical axis, is avoided.

According to the imaging apparatus of the first embodiment of the present disclosure or the imaging system of the second embodiment of the present disclosure, a notch portion is provided on a part of a circumference of the rotation ring of the body mount. Therefore, it is possible to avoid the interference between the rotation ring of the body mount and the protruding component of the lens or the adapter. It should be noted that the effect described herein is not necessarily limited, and may be any one of the effects described in the present disclosure.

### BRIEF DESCRIPTION OF DRAWINGS

FIG. 1 is a right side view illustrating an appearance of an imaging system according to an embodiment of the present disclosure;

FIG. 2 is a right side view illustrating an appearance of the imaging apparatus shown in FIG. 1;

FIG. 3 is a front view illustrating an appearance of the imaging apparatus shown in FIG. 2 as viewed from the front;

FIG. 4 is a perspective view illustrating a configuration of a body mount shown in FIG. 3 in a state where the body mount is drawn from a casing member as viewed from the upper right side;

FIG. 5 is a front view illustrating a situation where a rotation ring shown in FIG. 4 is at an initial position;

FIG. 6 is a front view illustrating a situation where a rotation ring shown in FIG. 4 is at a fastening position;

FIG. 7 is a perspective view illustrating a configuration where an adapter having a flange back adjustment mechanism is provided on the body mount shown in FIG. 4 as viewed from the lower right side, and is a perspective view illustrating a situation where the rotation ring shown in FIG. 4 is at the initial position;

FIG. 8 is a perspective view illustrating a configuration where an adapter having a flange back adjustment mechanism is provided on the body mount shown in FIG. 4 as viewed from the lower right side, and is a perspective view illustrating a situation where the rotation ring shown in FIG. 4 is at the fastening position;

FIG. 9 is a right side view illustrating the body mount and the adapter shown in FIG. 8;

FIG. 10 is a perspective view illustrating a part of the imaging system according to Modification Example 1, and is a perspective view illustrating a configuration where an adapter having a phase difference detection type autofocus (AF) sensor is mounted on the body mount as viewed from the lower right side;

FIG. 11 is a perspective view illustrating a part of the imaging system according to Modification Example 2, and is a perspective view illustrating a configuration where a lens having a motorized zoom mechanism is mounted on the body mount through the adapter as viewed from the lower right side;

FIG. 12 is a perspective view illustrating a configuration of a body mount shown in FIG. 11 in a state where the body mount is drawn from a casing member as viewed from the upper right side;

FIG. 13A is a front view of the adapter shown in FIG. 11;

FIG. 13B is a cross-sectional view of the adapter taken along the line XIIIB-XIIIB of the front view;

FIG. 14 is a rear view of the adapter shown in FIGS. 13A and 13B;

FIG. 15 is a front view illustrating a situation where the adapter shown in FIGS. 13A and 13B is mounted on the body mount shown in FIG. 12;

FIG. 16A is a front view of an adapter according to Modification Example 3;

FIG. 16B is a cross-sectional view of the adapter taken along the line XVIB-XVIB of the front view;

FIG. 17 is a rear view of the adapter shown in FIGS. 16A and 16B;

FIG. 18 is a front view illustrating a situation where a mount-release lever of the adapter shown in FIGS. 16A and 16B is at the initial position when the adapter is mounted on the body mount shown in FIG. 12;

FIG. 19 is a front view illustrating a situation where a mount-release lever of the adapter shown in FIGS. 16A and 16B is at the fastening position when the adapter is mounted on the body mount shown in FIG. 12;

FIG. 20 is a front view illustrating a configuration the body mount according to Modification Example 4 as viewed from the front side;

FIG. 21 is a front view illustrating a configuration the body mount according to Modification Example 5 as viewed from the front side;

FIG. 22 is a front view illustrating a configuration the body mount according to Modification Example 6 as viewed from the front side; and

FIG. 23 is a front view illustrating a configuration the body mount according to Modification Example 7 as viewed from the front side.

### DETAILED DESCRIPTION OF EMBODIMENTS

Hereinafter, embodiments of the present disclosure will be described in detail with reference to the accompanying drawings. It should be noted that description will be given in the following order:
1. Embodiment (an example in which an adapter having a flange back adjustment mechanism is mounted on a body mount);
2. Modification Example 1 (an example in which the adapter having a phase difference detection type AF sensor is mounted on the body mount in the embodiment);
3. Modification Example 2 (an example in which a lens having a motorized zoom mechanism is mounted on the body mount through an adapter of a bayonet type having a flange back shorter than a unique body flange back); 4. Modification Example 3 (an example in which the adapter is a spigot type in Modification Example 2);
5. Modification Example 4 (an example in which a first body contact point is disposed on the upper side and right side and a second body contact point is disposed on the upper side as the body mount is viewed from the front side);
6. Modification Example 5 (an example in which the first body contact point is disposed on the upper side and right side and the second body contact point is disposed on the left side as the body mount is viewed from the front side);
7. Modification Example 6 (an example in which the first body contact point is disposed on the upper side and right side and the second body contact point is disposed on the lower left side as the body mount is viewed from the front side); and
8. Modification Example 7 (an example in which the first body contact point is disposed on the left side and the second body contact point is disposed on the upper side as the body mount is viewed from the front side).

### Embodiment

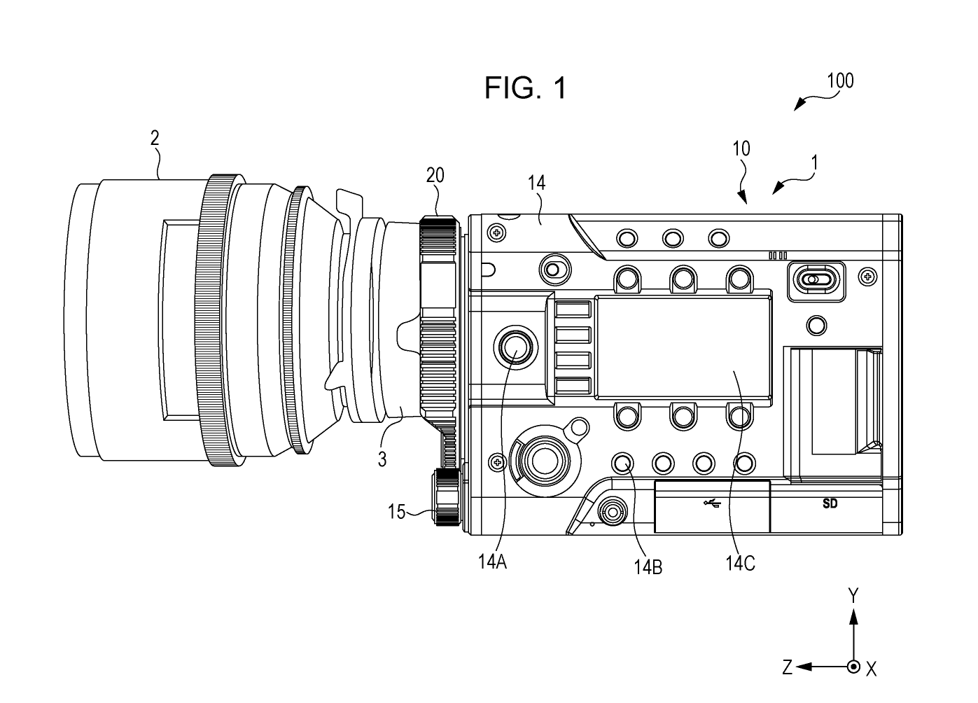

FIG. 1 shows an appearance of an imaging system 100 according to an embodiment of the present disclosure, as viewed from the right side surface. The imaging system 100 is, for example, a camera system for cinema photography, and has an imaging apparatus 1 and a lens 2 that is mountable on the imaging apparatus 1. The imaging apparatus 1 and the lens 2 are combined through, for example, an adapter 3. It should be noted that the lens 2 may be mounted on the imaging apparatus 1 through the adapter 3 as shown in FIG. 1 or may be directly mounted on the imaging apparatus 1 without using the adapter 3.

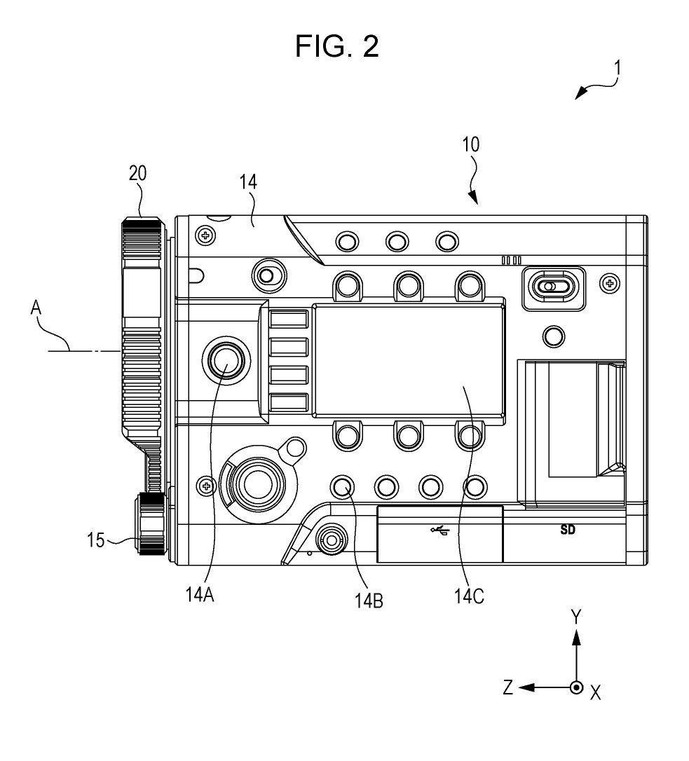

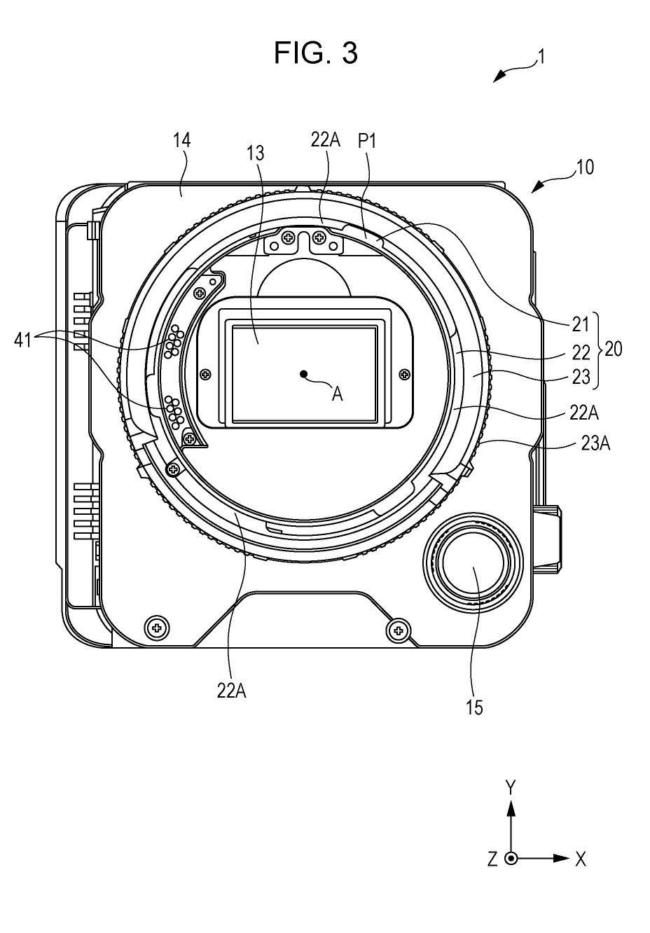

FIG. 2 shows an appearance of the imaging apparatus 1 shown in FIG. 1, as viewed from the right side surface. FIG. 3 shows an appearance of the imaging apparatus 1 shown in FIG. 2 as viewed from the front side. The imaging apparatus 1 is, for example, a camera for cinema photography, and has a body mount 20 in the front of the body 10. The body 10 has a casing member 14, and an imaging device (not shown in the drawing) is built into the casing member 14. On the respective surfaces of the casing member 14, there are appropriately provided not only a recording start button 14A, a menu selection button 14B, and a side panel 14C, but also various operation buttons and adjustment buttons, an accessory mount section such as a viewfinder, an external memory housing section, a USB connection section, a battery connection section, and the like.

The body mount 20 is a connection section between the body 10 and the lens 2 or the adapter 3 (refer to FIG. 1). The body mount 20 is, as shown in FIG. 3, formed in an annular shape centered on an optical axis A, on the front top center of the casing member 14 of the body 10. The optical component 13 is provided at the center of the inside of the body mount 20. An imaging device (not shown in the drawing) is disposed inside the optical component 13 (on the rear side in the optical axis direction). In a region around the optical component 13 inside the body mount 20, a body contact point 41 is provided. Further, an operation dial 15 is provided on the lower right side of the front surface of the casing member 14 of the body 10. The operation dial 15 is an operation section to assist a user to switch optical components such as ND filter (dark filter) disposed between the optical component 13 and the imaging device. It should be noted that the operation dial 15 is not limited to a rotation type (dial type) as shown in the embodiment, and a push type such as the operation button may be used.

In the following description and drawings, the Z indicates an optical axis direction. An optical axis A is a line that passes through the centers of lenses 2, an optical component 13, an imaging device (not shown in the drawing), and the like. In the optical axis direction Z, the lens 2 side is set as the front side, and the body 10 side is set as the rear side. An X direction indicates the left-right direction as the body mount 20 is viewed from the front side, and a Y direction indicates the up-down direction as the body mount 20 is viewed from the front side.

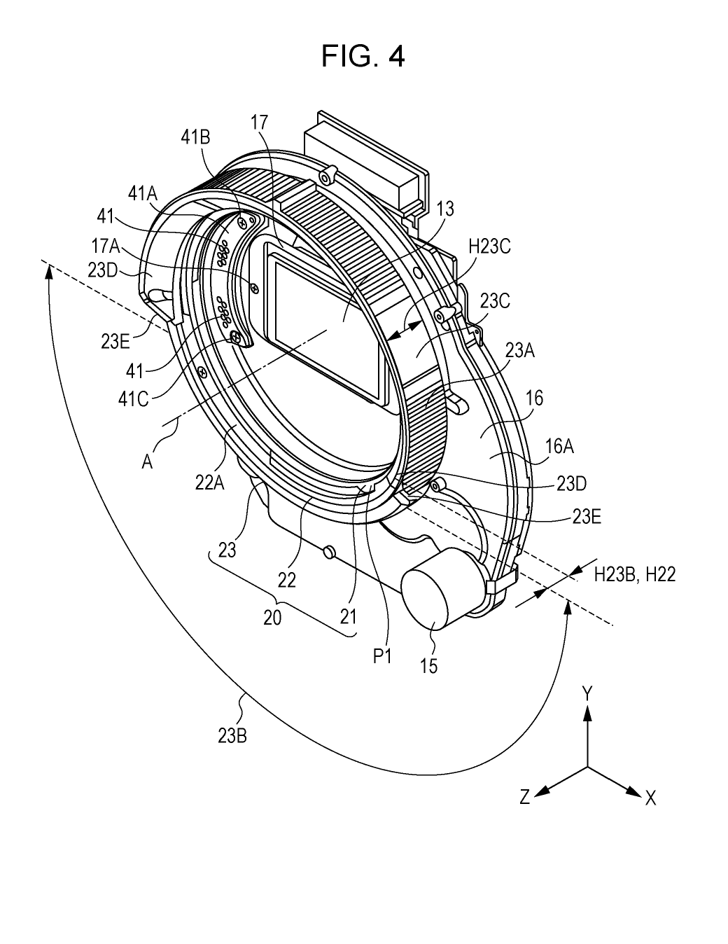

FIG. 4 shows a configuration of the body mount 20 shown in FIG. 3 in a state where the body mount is drawn from the casing member 14 as viewed from the upper right side. The body mount 20 is mounted on a chassis member 16 provided on the front surface of the body 10. The body mount 20 occupies a region ranging from the left side of the chassis member 16 to the upper side thereof. The chassis member 16 has a housing section 16A on the lower side and the lower right side of the body mount 20. The housing section 16A houses a turret (not shown in the drawing) that holds, for example, three or four optical components such as the above-mentioned ND filter. The above-mentioned operation dial 15 is provided on the lower right side of the housing section 16A. A user turns the operation dial 15 so as to rotate the turret, thereby switching the optical components such as the ND filter.

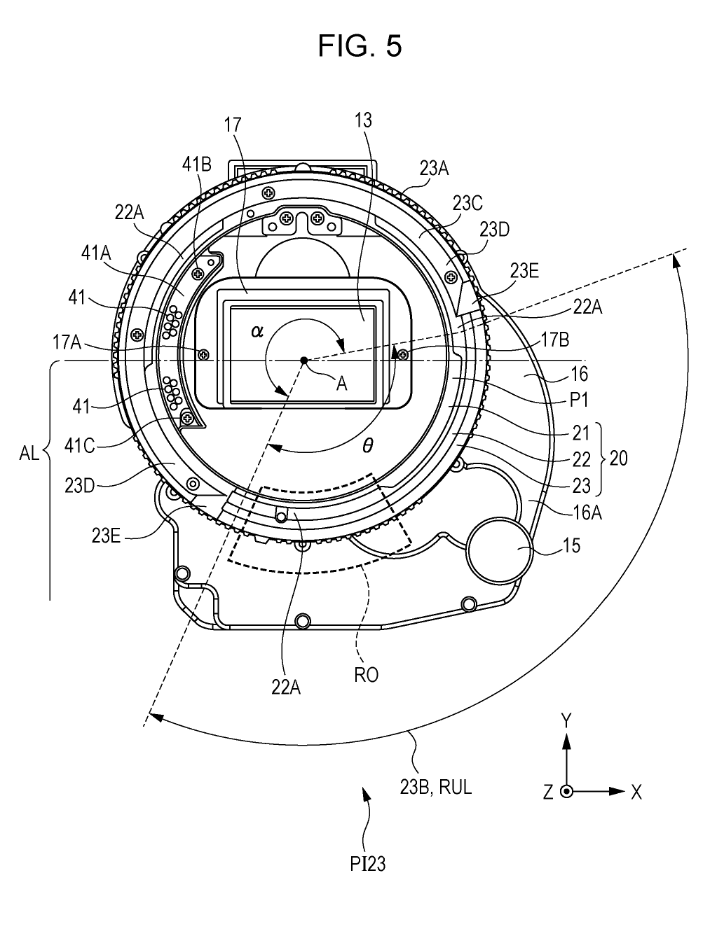

The optical component 13 is, for example, a glass plate member that has a function of protecting the imaging device and an appropriate optical function. The optical component 13 has, for example, a rectangular shape that is long in one direction, and is disposed at the center of the circular region surrounded by the body mount 20 so as to be horizontally long. In addition, it is needless to say that the imaging device is disposed to be horizontally long in a manner similar to that of the optical component 13. The optical component 13 is supported by an optical component supporting member 17. The optical component supporting member 17 is fixed onto the chassis member 16 through screws 17A and 17B (the screw 17B is not shown in FIG. 4; refer to FIG. 5).

The body contact point 41 performs electrical connection and communication between the lens 2 and the body 10. The body contact point 41 means, for example, a set of contact points. The set includes at least: a contact point for supplying power from the body 10 to the lens 2 mounted on the body 10; and a contact point for supplying a driving signal, which is for driving the lens 2, from the body 10 to the lens 2.

As the body mount 20 is viewed from the front side, the body contact point 41 is disposed on, for example, the left side of the circumference centered on the optical axis A. In other words, the body contact point 41 is disposed in an arc shape along the short side of the optical component 13 on the left side thereof. The body contact point 41 is supported by a body contact point supporting member 41A. The body contact point supporting member 41A is fixed onto and supported by the chassis member 16 through screws 41B and 41C.

In the body mount 20, for example, as a method of mounting the lens 2 or the adapter 3, a spigot method is employed. Thus, for example, the body mount 20 includes, in an order from the inner circumferential side, a fixing ring 21, a holding ring 22, and a rotation ring 23. By employing a spigot method in the body mount 20, a heavy large-sized lens 2 for cinema photography or the like can be robustly fastened to the body 10, and thus reliability increases. Further, an advantage consists in that it is possible to mount or unmount the lens 2 without rotating the lens 2.

The fixing ring 21 is a portion for connecting the adapter 3 or a rear end portion of the lens 2, and has a first reference surface P1. The first reference surface P1 is a surface on which the adapter 3 or the rear end portion of the lens 2 is mounted. A distance between the first reference surface P1 and the imaging surface (not shown in the drawing) in the optical axis direction Z is set as a flange back unique to the body 10.

The holding ring 22 is a portion for holding the adapter 3 or the rear end portion of the lens 2. The holding ring 22 has blades 22A at three locations (refer to FIG. 5) in the circumferential direction. The blades 22A are projected toward the upper side of the first reference surface P1 of the fixing ring 21. Thereby, the adapter 3 or the rear end portion of the lens 2 can be pinched to be interposed between the first reference surface P1 and the blades 22A. It should be noted that FIG. 4 shows only one of the three blades 22A on the lower left side.

The rotation ring 23 fastens and fixes the lens 2 or the adapter 3 and the body mount 20 by rotating the rotation ring 23 together with the holding ring 22 around the optical axis A. It is preferable that an unevenness slip stopper 23A be provided on the outer surface of the rotation ring 23 so as to help a user to easily turn the rotation ring 23 with a hand.

The rotation ring 23 has a notch portion 23B on a portion of the circumference. The notch portion 23B is configured to make a height H23B of the notch portion 23B lower than a height H23C of a standing wall portion 23C other than the notch portion 23B, in the optical axis direction Z, in a portion of the circumference of the rotation ring 23. Thereby, in the imaging apparatus 1 and the imaging system 100, it is possible to avoid interference between the rotation ring 23 of the body mount 20 and the protruding component which protrudes outward from the lens 2 or the adapter 3 in the diameter direction with respect to the optical axis A.

FIG. 5 shows a state where the rotation ring 23 shown in FIG. 4 is at an initial position PI23, that is, an unlocking state. At this time, an area RUL of the notch portion 23B of the rotation ring 23 occupies, for example, a region substantially ranging from the lower left side to the upper right side in the circumferential direction.

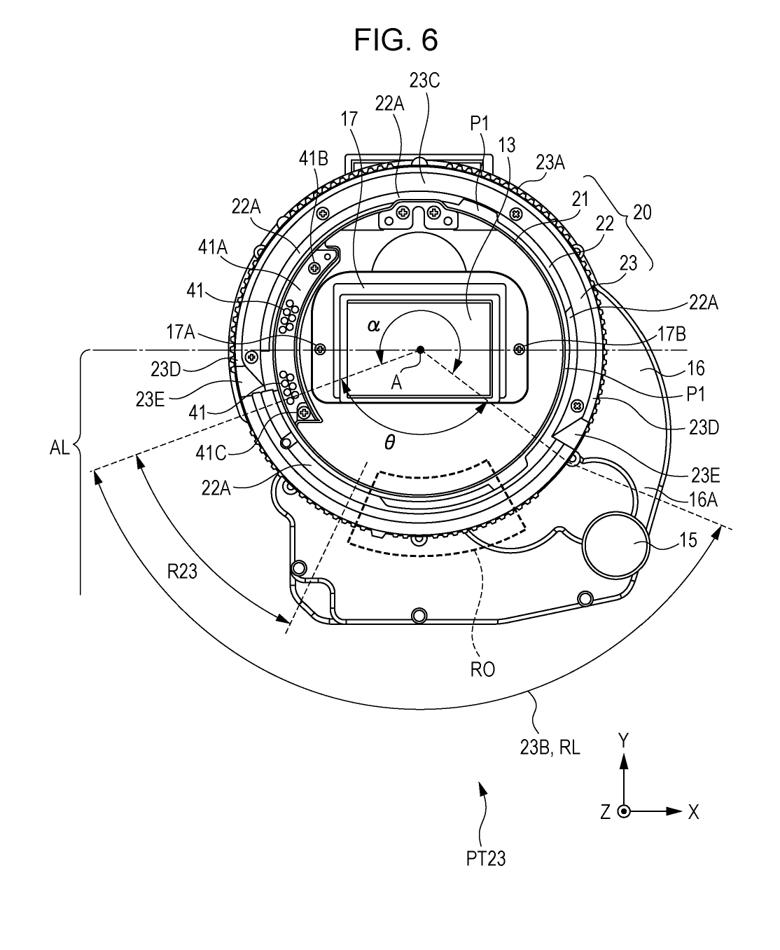

FIG. 6 shows a state where the rotation ring 23 shown in FIG. 4 is at a fastening position PT23, that is, a locking state. At this time, an area RL of the notch portion 23B of the rotation ring 23 occupies, for example, a region substantially ranging from the left side to the lower right side in the circumferential direction.

The rotation ring 23 is rotatable within a movable range R23 (refer to FIG. 6) between the initial position PI23 shown in FIG. 5 and the fastening position PT23 shown in FIG. 6. Further, it is preferable that the rotation ring 23 have an open region RO. In the open region RO, the area RUL of the notch portion 23B at the initial position PI23 overlaps with the range RL of the notch portion 23 at the fastening position PT23. That is, the open region RO is occupied by the notch portion 23B approximately at the time of mounting or unmounting the lens 2 or the adapter 3 independent of stroke of the rotation ring 23. Accordingly, in the open region RO, the protruding component which protrudes outward from the lens 2 or the adapter 3 in the diameter direction with respect to the optical axis A may be disposed. In this case, it is possible to further reliably avoid interference between the protruding component and the rotation ring 23 of the body mount 20.

It is preferable that the open region RO be provided in a region AL on the lower side of the optical axis A of the rotation ring 23, for example, as the body 10 is viewed from the front side. The reason is that, in most cases, the protruding component of the lens 2 or the adapter 3 is provided on the lower side of the lens 2 or the adapter 3. It is more preferable that, for example, as shown in FIGS. 5 and 6, the open region RO be provided on the lower side of the circumference centered on the optical axis A, as the body 10 is viewed from the front side.

It is preferable that a central angle θ of the notch portion 23B about the optical axis A be equal to or less than 180°, as shown in FIGS. 5 and 6. In other words, the rotation ring 23 has not only the notch portion 23B but also a standing wall portion 23C. It is preferable that a central angle α of the standing wall portion 23C about the optical axis A be equal to or greater than 180°. Thereby, it is possible to assist a user to easily turn the standing wall portion 23C with a hand, and thus operability of the mounting or the unmounting is less likely to be lowered. In addition, an uneven slip stopper 23A may be provided on only the standing wall portion 23C, and may be provided on both the standing wall portion 23C and the notch portion 23B.

As shown in FIG. 4, it is preferable that the height H23B of the notch portion 23B in the optical axis direction Z and the height H22 of the holding ring 22 in the optical axis direction Z be, for example, the same or approximately the same (not geometrically the same but substantially the same). In other words, it is preferable that the notch portion 23B and the holding ring 22 be formed to be coplanar or approximately coplanar (not geometrically coplanar but substantially coplanar). If the height H23B of the notch portion 23B is higher than the height H22 of the holding ring 22, the effect of avoiding the interference between the protruding component and the notch portion 23B of the lens 2 or the adapter 3 is reduced. In contrast, if the height H23B of the notch portion 23B is lower than the height H22 of the holding ring 22, there is a concern that the strength of the notch portion 23B may be lowered. In addition, it is preferable that the height H22 of the holding ring 22 in the optical axis direction Z be set as a value capable of ensuring the strength of the blades 22A. The height H23C of the standing wall portion 23C in the optical axis direction Z has an upper limit for avoiding the interference between the standing wall portion 23C and the lens 2 or the adapter 3, but the height H23C is not particularly limited except by the limit.

It is preferable that, as shown in FIG. 4, a taper surface 23E be formed on an end portion 23D of the standing wall portion 23C. Thereby, the inclination of the end portion 23D of the standing wall portion 23C is set to be gentle, and thus it is possible to increase safety.

Further, it is preferable that, as shown in FIG. 5, the area RUL of the notch portion 23B at the initial position PI23 and at least a part of the body contact point 41 be different in positions in the rotation direction with respect to the optical axis A. That is, in FIG. 5, the body contact point 41 is provided on the left side of the optical component 13 (imaging device), but the notch portion 23B is positioned on the lower right side. Since a portion of the rotation ring 23 corresponding to the body contact point 41 is not notched, a user is less likely to contaminate the body contact point 41 by accidentally touching the body contact point 41. As a result, it is possible to keep the body contact point 41 clean.

FIG. 5 shows a case where the area RUL of the notch portion 23B at the initial position PI23 and the entire body contact point 41 are different in positions in the rotation direction with respect to the optical axis A. However, it suffices that the area RUL of the notch portion 23B at the initial position PI23 and a part of the body contact point 41 are different in positions in the rotation direction with respect to the optical axis A.

In contrast, it is preferable that, as shown in FIG. 6, the area RL of the notch portion 23B at the fastening position PT23 and at least a part of the body contact point 41 be different in positions in the rotation direction with respect to the optical axis A. That is, in FIG. 6, the body contact point 41 is provided on the left side of the optical component 13 (imaging device), but the notch portion 23B is positioned on the lower side (the lower side and slightly on the left side). Since a portion of the rotation ring 23 corresponding to the body contact point 41 is not notched, a user is less likely to contaminate the body contact point 41 by accidentally touching the body contact point 41. As a result, it is possible to keep the body contact point 41 clean.

FIG. 6 shows a case where the area RUL of the notch portion 23B at the initial position P123 and a part of the body contact point 41 are different in positions in the rotation direction with respect to the optical axis A. However, the area RUL of the notch portion 23B at the initial position P123 and the entire body contact point 41 may be different in positions in the rotation direction with respect to the optical axis A.

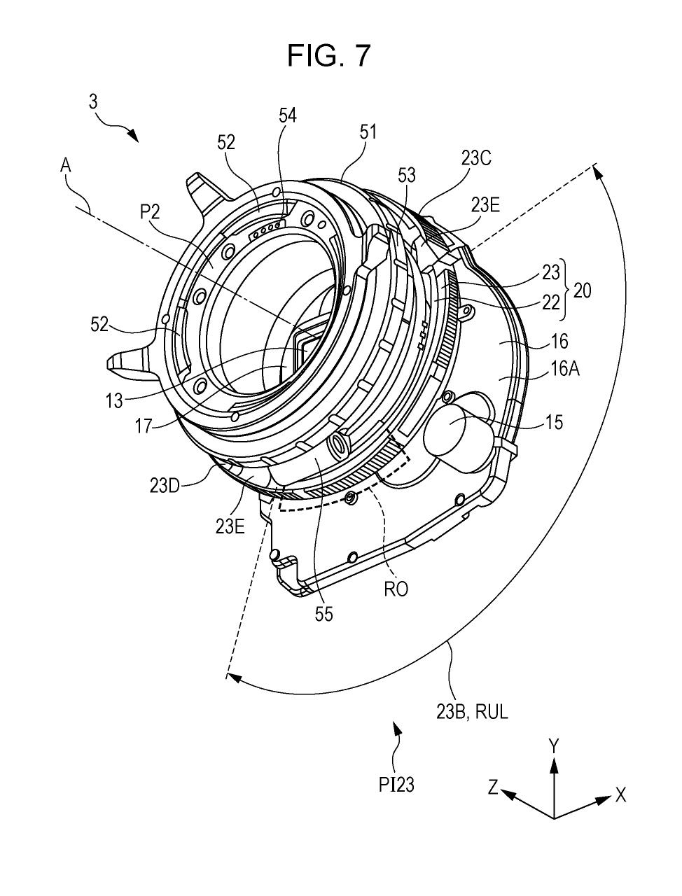

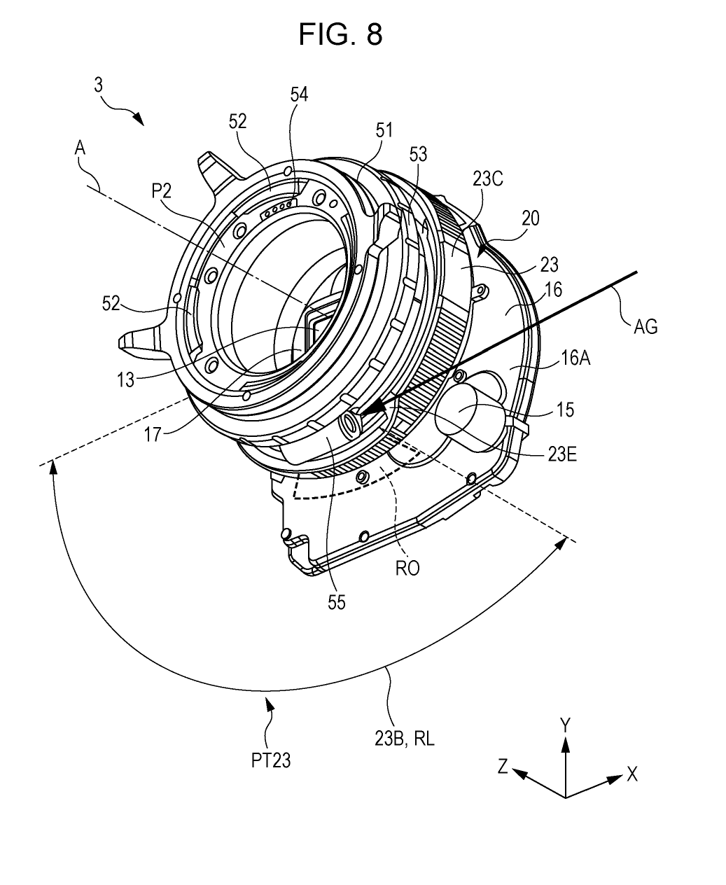

FIGS. 7 and 8 show a configuration where the adapter 3 shown in FIG. 1 is provided on the body mount 20 shown in FIG. 4 as viewed from the lower right side. FIG. 7 shows a situation where the rotation ring 23 is at the initial position P123, and FIG. 8 shows a situation where the rotation ring 23 is at the fastening position PT23.

The adapter 3 is to change the body mount 20 of the imaging apparatus 1 into a PL mount which is a cinema industry standard, and has an adapter main body 51 having a cylindrical shape. The adapter 3 can be mounted on the body mount 20 by a spigot method, and has outer blades (not shown in the drawing) for mounting on the body mount 20 on the outer circumference side. Further, the adapter 3 can be equipped with the lens 2 by the spigot method, and has a second reference surface P2 on which the lens 2 is mounted, inner blades 52 on the inner circumference side, and the fastening section 53. The fastening section 53 detachably fixes the lens 2 onto the second reference surface P2 by rotating itself around the optical axis A. An adapter contact point 54 is provided on the second reference surface P2. As the body mount 20 is viewed from the front side, the adapter contact point 54 is disposed on the upper right side of the circumference centered on the optical axis A. The adapter contact point 54 is connected to the body contact point 41 through wiring (not shown in the drawing) which is connected to the inside of the adapter main body 51.

Further, the adapter 3 has a flange back adjustment mechanism (not shown in the drawing). A flange back adjustment knob 55, which constitutes a part of the flange back adjustment mechanism, protrudes outward from the adapter main body 51 in the diameter direction with respect to the optical axis A. The flange back adjustment knob 55 corresponds to one specific example of the “protruding component” in the present disclosure.

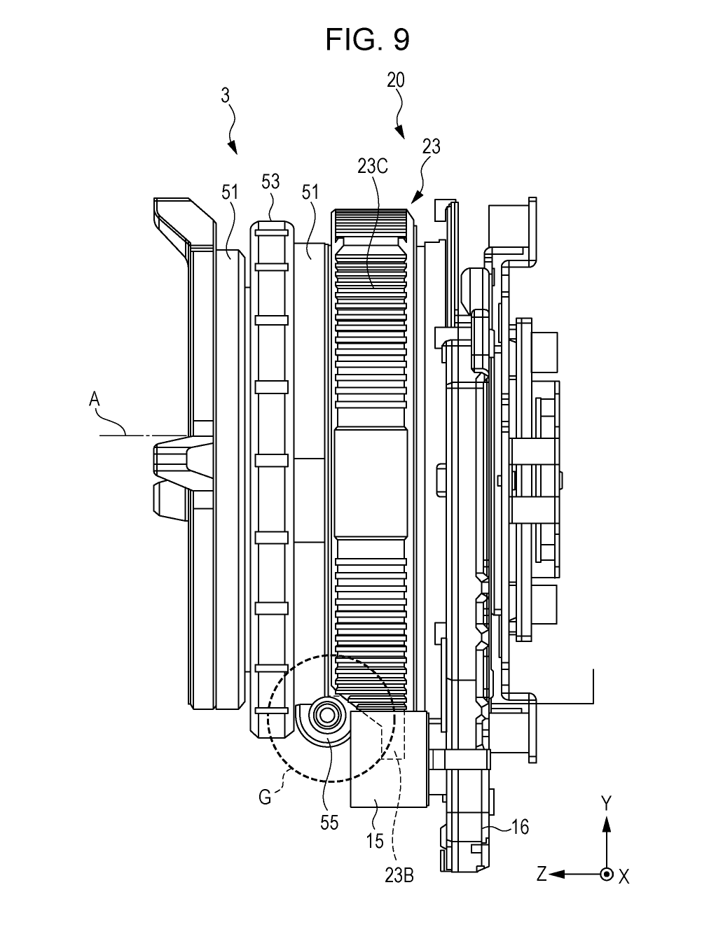

FIG. 9 shows a configuration of the body mount 20 and the adapter 3 shown in FIG. 8 as viewed from the right side surface. As shown in FIG. 9, when the rotation ring 23 is at the fastening position PT23, it is preferable that the notch portion 23B and the operation dial 15 form a gap G which gives access to the flange back adjustment knob 55 from a side surface of the body mount 20. Thereby, as indicated by the arrow AG of FIG. 8, a tool (such as a wrench not shown in the drawing) for flange back adjustment is inserted into the gap G from the right side surface of the adapter 3, and the tool can access the flange back adjustment knob 55.

In the imaging system 100, for example, in the following manner, the adapter 3 and the lens 2 are mounted on the imaging apparatus 1.

First, when the rotation ring 23 is at the initial position PI23 shown in FIG. 5 (unlocking state), the outer blades (not shown in the drawing) on the outer circumference side of the adapter 3 are inserted between the blades 22A of the holding ring 22 of the body mount 20. Subsequently, the rotation ring 23 is set at the fastening position PT23 shown in FIG. 6 by rotating the rotation ring 23 in a tightening direction (locking state). Thereby, the outer blades of the adapter 3 are pinched between the first reference surface P1 and the blades 22A of the body mount 20, thereby mounting and fixing the adapter 3 on the first reference surface P1 of the body mount 20.

Here, the notch portion 23B is provided on a part of the circumference of the rotation ring 23 of the body mount 20. Therefore, interference between the rotation ring 23 of the body mount 20 and the flange back adjustment knob 55, which protrudes outward from the adapter 3 in the diameter direction with respect to the optical axis A, is avoided.

Further, as shown in FIG. 9, when the rotation ring 23 is at the fastening position PT23, the notch portion 23B and the operation dial 15 form the gap G which gives access to the flange back adjustment knob 55 from the side surface of the body mount 20. Accordingly, when a user wants to adjust the flange back, as indicated by the arrow AG of FIG. 8, a tool (such as a wrench not shown in the drawing) for flange back adjustment is inserted into the gap G from the right side surface of the adapter 3, and the tool can access the flange back adjustment knob 55.

Subsequently, the blades (not shown in the drawing) of the lens 2 at the rear end portion are inserted between the inner blades 52 of the adapter 3 on the inner circumference side, and the fastening section 53 of the adapter 3 is rotated in the tightening direction. Thereby, the blades of the lens 2 at the rear end portion are pinched between the second reference surface P2 and the inner blades 52 of the adapter 3, thereby mounting and fixing the lens 2 on the second reference surface P2 of the adapter 3.

As described above, in the embodiment, the notch portion 23B is provided on a part of the circumference of the rotation ring 23 of the body mount 20. Therefore, it is possible to avoid the interference between the rotation ring 23 of the body mount 20 and the protruding component of the lens 2 or the adapter 3 such as the flange back adjustment knob 55. Thereby, while ensuring an advantage of reliable fastening in the spigot method, it is possible to ensure space for mounting of the lens 2 or the adapter 3 which is out of the standard of the body mount 20. Accordingly, it is possible to mount and use more types of the lens 2 or the adapter 3 on the mount body 20, and it is possible to increase compatibility between the body 10 and the lens 2 or the adapter 3.

Further, the rotation ring 23 has the open region RO. Thereby, in the open region RO, the area RUL of the notch portion 23B at the initial position PI23 overlaps with the range RL of the notch portion 23 at the fastening position PT23. Accordingly, the open region RO is occupied by the notch portion 23B approximately at the time of mounting or unmounting the lens 2 or the adapter 3 independent of stroke of the rotation ring 23. Thereby, it is possible to reliably avoid the interference between the rotation ring 23 of the body mount 20 and the protruding component of the lens 2 or the adapter 3.

Further, the open region RO is provided in the region AL on the lower side of the optical axis A of the rotation ring 23, for example, as the body 10 is viewed from the front side. Accordingly, it is possible to reliably avoid the interference between the rotation ring 23 of the body mount 20 and the protruding component of the lens 2 or the adapter 3.

### Modification Examples 1 and 2

In the embodiment, as an example of the protruding component of the lens 2 or the adapter 3, the flange back adjustment knob 55 of the adapter 3 has been described. In the following modification examples (Modification Examples 1 and 2), another example of the protruding component will be described.

### Modification Example 1

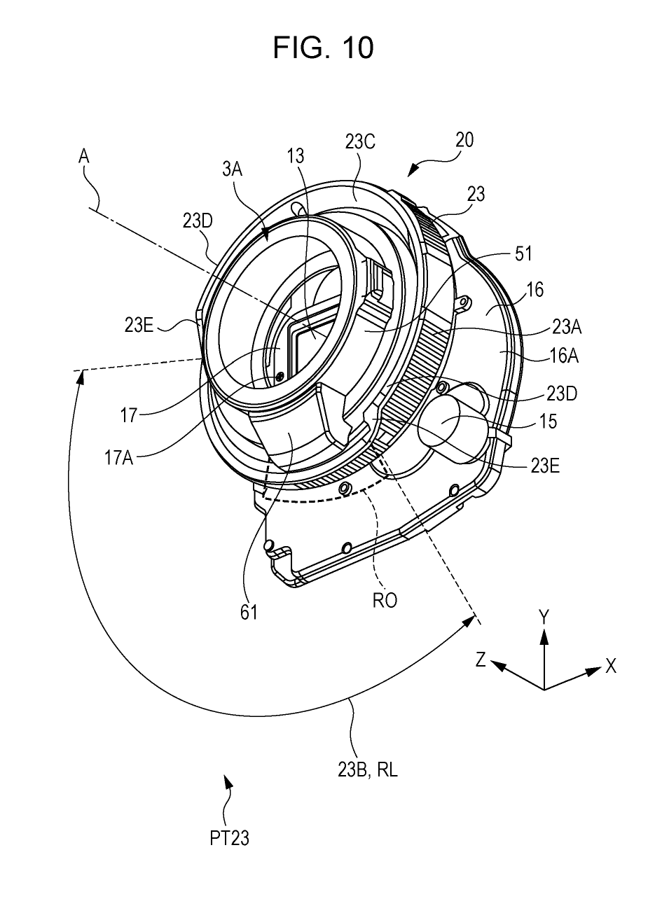

FIG. 10 shows a part of the imaging system 100 according to Modification Example 1, and shows a configuration where an adapter 3A having a phase difference detection type autofocus (AF) sensor 61 as the protruding component is mounted on the body mount 20 shown in FIG. 4 as viewed from the lower right side. In addition, FIG. 10 shows a situation where the body mount 20 is drawn from the casing member 14.

The adapter 3A is to change the body mount 20 of the imaging apparatus 1 into a mount which is capable of mounting the lens (not shown in the drawing) for a single-lens reflex camera, and has an adapter main body 51 having a cylindrical shape. The adapter 3A can be mounted on the body mount 20 by the spigot method, and has outer blades (not shown in the drawing) for mounting on the body mount 20 on the outer circumference portion.

The adapter 3A has the phase difference detection type AF sensor 61 on the lower side of the circumference centered on the optical axis A. From the optical point of view, the phase difference detection type AF sensor 61 is provided to protrude outward from the adapter main body 51 in the diameter direction with respect to the optical axis A. Further, the phase difference detection type AF sensor 61 is provided in a region corresponding to the open region RO in the circumference centered on the optical axis A.

In the present modification example, the notch portion 23B is provided on a part of the circumference of the rotation ring 23 of the body mount 20. Therefore, the interference between the rotation ring 23 of the body mount 20 and the protruding component of the adapter 3A such as the phase difference detection type AF sensor 61 is avoided. Further, by forming a margin space on the lower side of the adapter 3A, the AF sensor 61 can be disposed on the adapter 3A side, and various functions can be added to the adapter 3A.

### Modification Example 2

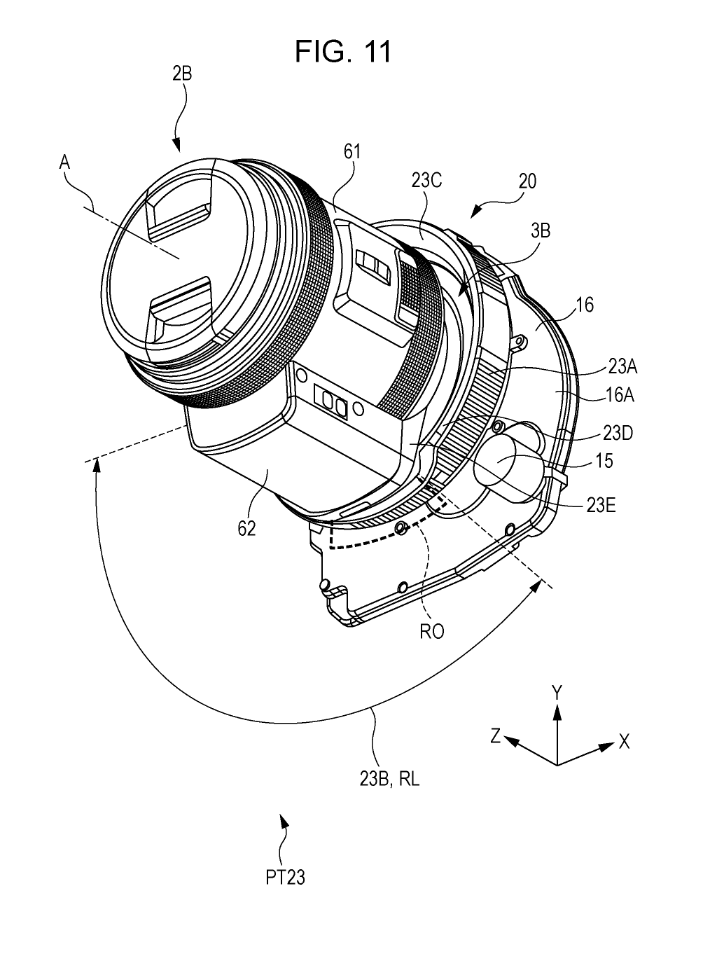

FIG. 11 shows a part of the imaging system 100 according to Modification Example 2, and shows a configuration where the lens 2B having a motorized zoom mechanism 62 as the protruding component is mounted on the body mount 20 through the adapter 3B as viewed from the lower right side. In addition, FIG. 11 shows a situation where the body mount 20 is drawn from the casing member 14.

The lens 2B is, for example, a lens for a mirrorless camera, and has a lens main body 61 having a cylindrical shape. Further, the lens 2B has the motorized zoom mechanism 62 on the lower side of the circumference centered on the optical axis A. The motorized zoom mechanism 62 is provided to protrude outward from the lens main body 61 in the diameter direction with respect to the optical axis A. Further, the motorized zoom mechanism 62 is provided in a region corresponding to the open region RO in the circumference centered on the optical axis A.

In the present modification example, the notch portion 23B is provided on a part of the circumference of the rotation ring 23 of the body mount 20. Therefore, the interference between the rotation ring 23 of the body mount 20 and the protruding component of the lens 2B such as the motorized zoom mechanism 62 is avoided.

In addition, although not shown in the drawing, even for a tripod fixing member provided on the lens 2B side, in a manner similar to the motorized zoom mechanism 62, by providing the notch portion 23B on a part of the circumference of the rotation ring 23, it is possible to avoid the interference between the tripod fixing member and the rotation ring 23 of the body mount 20.

Hereinafter, the body mount 20 and the adapter 3B of the present modification example will be described in detail.

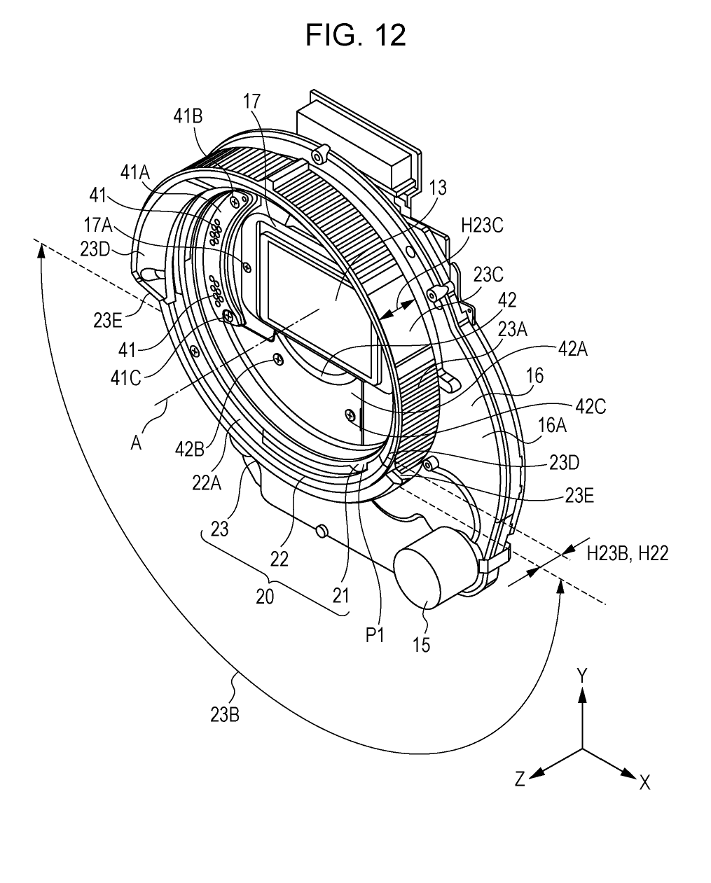

FIG. 12 shows a configuration of the body mount 20 shown in FIG. 11 in a state where the body mount is drawn from the casing member 14 as viewed from the upper right side. The imaging apparatus 1 of the present modification example is different from that of the embodiment in that the first body contact point 41 and the second body contact point 42 are provided in a region around the optical component 13 inside the body mount 20. Except for this, the imaging apparatus 1 of the present modification example has the same configuration, effects, and advantages as those of the embodiment. Accordingly, the corresponding components will be referenced by the same numerals and signs.

The first body contact point 41 has the same configuration as the body contact point 41 of the embodiment. That is, the first body contact point 41 performs electrical connection and communication between the lens 2 (refer to FIG. 1) and the body 10. The first body contact point 41 means, for example, a set of contact points. The set includes at least: a contact point for supplying power from the body 10 to the lens 2 mounted on the body 10; and a contact point for supplying a driving signal, which is for driving the lens 2, from the body 10 to the lens 2.

As the body mount 20 is viewed from the front side, the first body contact point 41 is disposed on, for example, the left side of the circumference centered on the optical axis A. In other words, the first body contact point 41 is disposed in an arc shape along the short side of the optical component 13 on the left side thereof. The first body contact point 41 is supported by a first body contact point supporting member 41A. The first body contact point supporting member 41A is fixed onto and supported by the chassis member 16 through screws 41B and 41C.

The second body contact point 42 performs electrical connection and communication between the lens 2B (refer to FIG. 11) and the body 10. The second body contact point 42 means, for example, a set of contact points. The set includes at least: a contact point for supplying power from the body 10 to the lens 2B mounted on the body 10; and a contact point for supplying a driving signal, which is for driving the lens 2B, from the body 10 to the lens 2B.

As the body mount 20 is viewed from the front side, the second body contact point 42 is disposed on, for example, the lower side of the circumference centered on the optical axis A. In other words, the second body contact point 42 is disposed in an arc shape along the long side of the optical component 13 on the lower side thereof. The second body contact point 42 is supported by a second body contact point supporting member 42A. The second body contact point supporting member 42A is fixed onto and supported by the chassis member 16 through screws 42B and 42C.

As described above, by providing the first body contact point 41 and the second body contact point 42 on the body 10 side, contact points and wiring do not have to be provided on the adapter 3B. Accordingly, it is possible to perform electrical connection and communication between the lens 2B and the body 10 while achieving reduction in the thickness of the adapter 3B. Particularly, as described later, this configuration is appropriate for a case where the lens 2B or the adapter 3B having a flange back shorter than a flange back unique to the body 10 is mounted on the body 10.

It is preferable that the second body contact point 42 be positioned to be closer to the inner circumference side than the first body contact point 41 in the diameter direction with respect to the optical axis A. Thereby, as described later, in the state where the adapter 3B is mounted on the first reference surface P1, the second body contact point 42 is exposed through an opening 33A which is provided on the inner circumference side of the adapter 3B and will be described later, whereby the second body contact point 42 and the lens 2B can be easily connected. Further, by concealing the first body contact point 41 in the adapter 3B, it is possible to easily and visually recognize that it is difficult for the lens 2B to be mounted. As a result, it becomes easy to perform lens mounting.

Further, it is preferable that the first body contact point 41 and the second body contact point 42 be disposed at different positions in the direction of the circumference centered on the optical axis A. Thereby, it is possible to simplify a configuration of the first body contact point supporting member 41A and the second body contact point supporting member 42A. In addition, the first body contact point 41 and the second body contact point 42 may be disposed at the same position or substantially the same position in the direction of the circumference centered on the optical axis A. The modification example of arrangement of the first body contact point 41 and the second body contact point 42 will be described later.

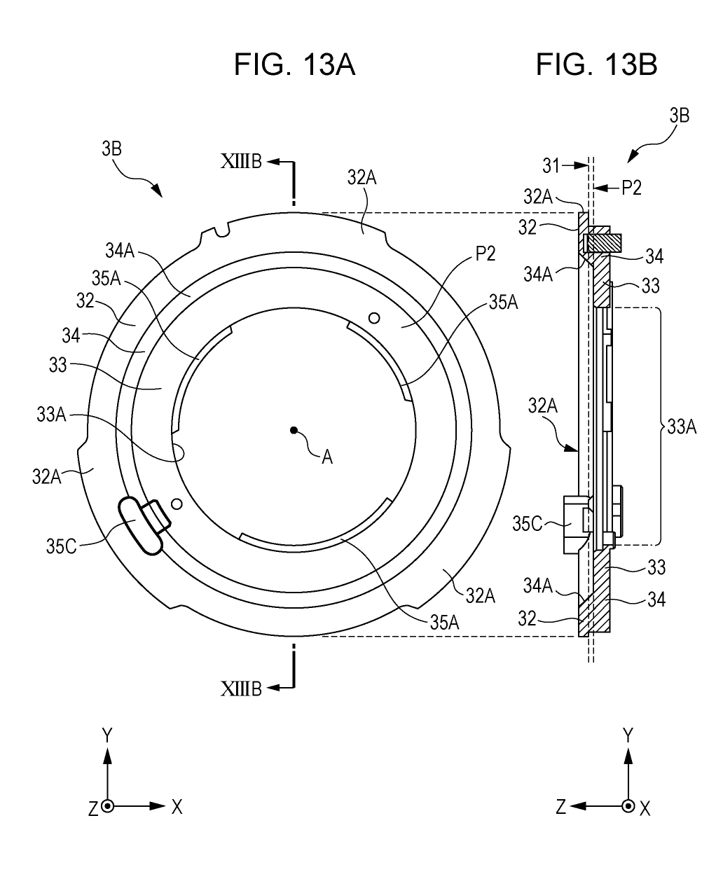

FIG. 13A shows a configuration of the adapter 3B according to the present modification example, as viewed from the front side. FIG. 13B shows a cross-sectional configuration of the adapter 3B taken along the line XIIIB-XIIIB of FIG. 13A.

The adapter 3B is to convert the body mount 20 of the imaging apparatus 1 into a mount on which a lens for a mirrorless camera can be mounted. Specifically, the adapter 3B has, for example, an outer circumferential portion 32, an inner circumferential portion 33, and an intermediate portion 34. An opening 33A having a circular shape is formed on the inner circumference side of the adapter 3B. An aperture of the adapter 3B is smaller than an aperture of the body mount 20.

The outer circumferential portion 32 is a portion mounted on the first reference surface P1 of the body mount 20, and has a mount surface 31. The mount surface 31 is a surface that is in contact with a first reference surface P1 in a state where the surface is mounted on the first reference surface P1 of the body mount 20. The outer circumferential portion 32 has outer blades 32A that are provided at three locations in the circumferential direction and are for mounting on the body mount 20.

The inner circumferential portion 33 is formed in a concentric shape inside the outer circumferential portion 32, and has a second reference surface P2. It is preferable that the second reference surface P2 be positioned to be closer to the body 10 side than the mount surface 31 in the optical axis direction Z. With such a configuration, the lens 2B having the flange back shorter than the flange back unique to the body 10 can be mounted on the body mount 20 through the adapter 3B.

The intermediate portion 34 is a portion that connects the outer circumferential portion 32 and the inner circumferential portion 33 in the optical axis direction Z. It is preferable that the intermediate portion 34 have an appropriate level difference in accordance with the difference in flange back between the body 10 and the lens 2B. In this case, it is preferable that the intermediate portion 34 have an inclined surface 34A connecting the outer circumferential portion 32 and the inner circumferential portion 33. Since the intermediate portion 34 has the inclined surface 34A, the intermediate portion 34 can be adapted to various lens shapes. In addition, by providing the inclined surface 34A, extra space is formed around a lens release button 35C to be described later. Thus, it becomes easy for a user to press the lens release button 35C.

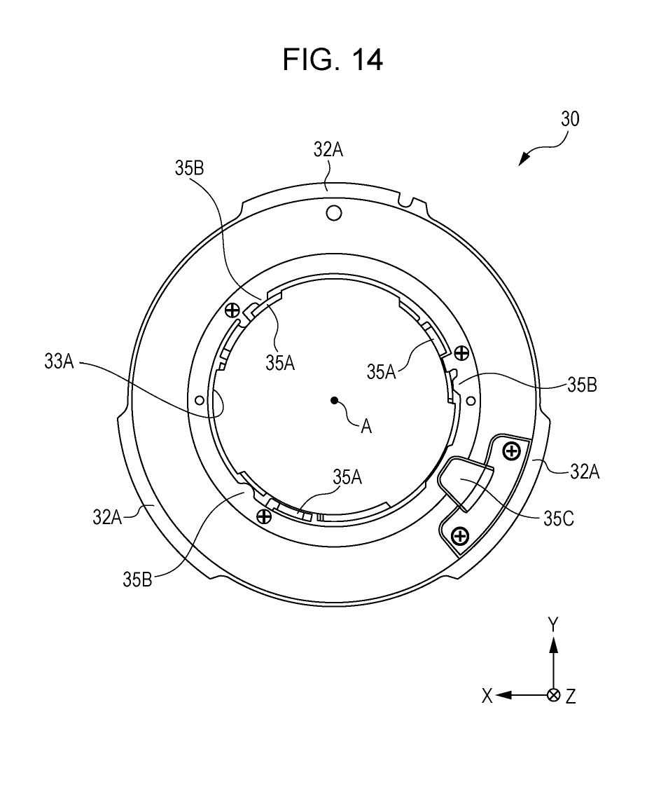

FIG. 14 shows a configuration of the adapter 3B shown in FIGS. 13A and 13B viewed from the rear side. The adapter 3B uses the bayonet method as a method of mounting the lens 2B, and thus has, for example, the inner blades 35A, the bayonet mechanisms 35B, and the lens release button 35C.

The inner blades 35A are for mounting the lens 2B on the second reference surface P2. For example, as shown in FIG. 13A, the inner blades 35A are provided at three locations in the circumferential direction of the opening 33A of the inner circumferential portion 33.

The bayonet mechanism 35B is, as shown in FIG. 14, a spring mechanism that is provided on the rear side of the inner blade 35A, and is configured to press the lens 2B to the second reference surface P2 and suppress positional deviation and displacement of the lens 2B in the optical axis direction Z.

The lens release button 35C is, as shown in FIG. 13A, a push button for releasing the lens 2B from the adapter 3B. The lens release button 35C is provided on the lower left side of the intermediate portion 34 and the outer circumferential portion 32.

It is preferable that the lens release button 35C be projected to be closer to the lens 2B side than the front surface 32A of the outer circumferential portion 32 in the optical axis direction Z, as shown in FIG. 13B. With such a configuration, a user is able to easily press the lens release button 35C with a flat portion of a finger rather than a nail tip of a finger. As a result, usability thereof is improved.

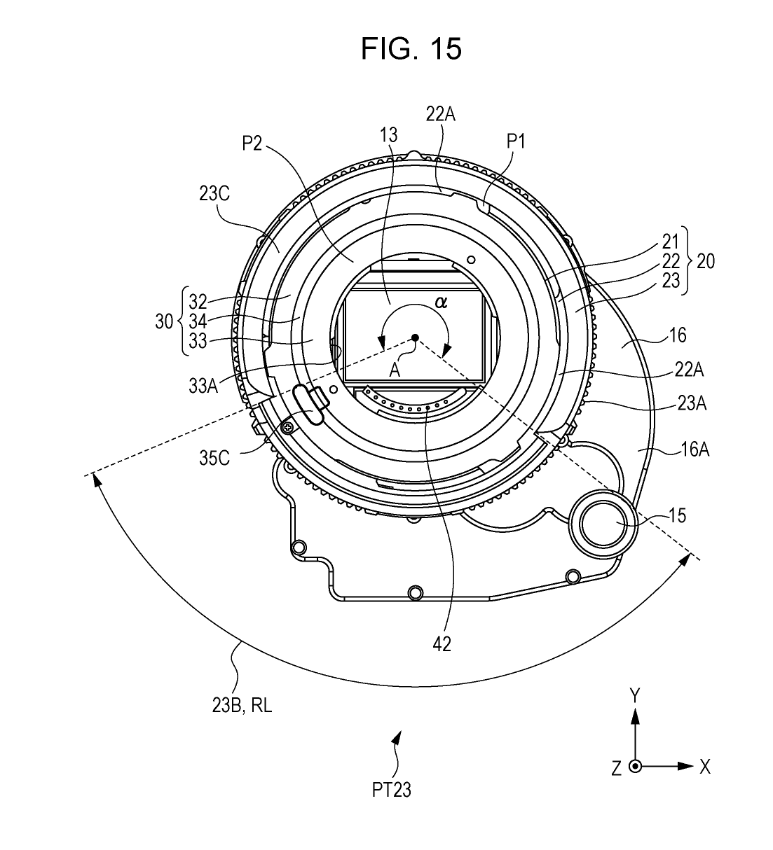

FIG. 15 shows a configuration of the body mount 20 in a state where the adapter 3B is mounted on the body mount 20 shown in FIG. 12, as viewed from the front side.

In the state where the adapter 3B is mounted on the first reference surface P1, the first body contact point 41 is concealed in the adapter 3B. Thus, it is preferable that the second body contact point 42 be exposed through the opening 33A on the inner circumference side of the adapter 3B. Thereby, as described later, the lens 2B and the second body contact point 42, which is exposed through the opening 33A of the adapter 3B, can be easily connected. Further, by concealing the first body contact point 41 in the adapter 3B, it is possible to easily and visually recognize that it is difficult for the lens 2B to be mounted. As a result, it becomes easy to perform lens mounting.

It is preferable that the lens release button 35C of the adapter 3B be provided in the area RL of the notch portion 23B at the fastening position PT23. Thereby, a user is able to easily press the lens release button 35C, and thus convenience in use is improved.

Further, it is preferable that the lens release button 35C of the adapter 3B be positioned on the obliquely lower side of the circumference centered on the optical axis A, for example, on the lower left side or the lower right side thereof, as the body mount 20 is viewed from the front side. When the lens release button 35C is disposed on the lower side of the circumference centered on the optical axis A, there is a concern that it is difficult to operate the lens release button 35C due to interference between the button and the protruding component which becomes adjunct onto the lower side of the lens 2B. Further, in most cases, an assistant cameraman who assists a main cameraman stands beside the imaging apparatus 1 and operates the lens release button 35C. Accordingly, since the lens release button 35C is disposed on the lower left side or the lower right side, it becomes easy for an assistant cameraman to operate the lens release button 35C. Accordingly, a working efficiency improves. In FIG. 15, the operation dial 15 is disposed on the lower right side, and the lens release button 35C is disposed on the lower left side. However, both the operation dial 15 and the lens release button 35C may be disposed on the lower left side or on the lower right side.

In the imaging system 100, for example, in the following manner, the adapter 3B and the lens 2B are mounted on the imaging apparatus 1.

First, when the rotation ring 23 is at the initial position PI23 shown in FIG. 5 (unlocking state), the outer blades 32A on the outer circumferential portion 32 of the adapter 3B are inserted between the blades 22A of the holding ring 22 of the body mount 20. Subsequently, the rotation ring 23 is set at the fastening position PT23 shown in FIG. 6 by rotating the rotation ring 23 in a tightening direction (locking state). Thereby, the outer blades 32A of the adapter 3B are pinched between the first reference surface P1 and the blades 22A of the body mount 20, thereby mounting and fixing the adapter 3B on the first reference surface P1 of the body mount 20.

Thereafter, the blades (not shown in the drawing) of the lens 2B at the rear end portion are inserted between the inner blades 35A of the inner circumference portion 33 of the adapter 3B, and the lens 2B is rotated. Thereby, the blades of the lens 2B at the rear end portion are pinched between the second reference surface P2 and the inner blades 35A of the adapter 3B, thereby mounting and fixing the lens 2B on the second reference surface P2 of the adapter 3B.

Here, the notch portion 23B is provided on a part of the circumference of the rotation ring 23 of the body mount 20. Therefore, the interference between the rotation ring 23 of the body mount 20 and the protruding component of the lens 2B such as the motorized zoom mechanism 62 is avoided.

As described above, in the present modification example, in a manner similar to that of the embodiment, the notch portion 23B is provided on a part of the circumference of the rotation ring 23 of the body mount 20. Accordingly, it is possible to avoid the interference between the rotation ring 23 of the body mount 20 and the protruding component of the lens 2B such as the motorized zoom mechanism 62.

In the adapter 3B of the present modification example, the second reference surface P2 is positioned to be closer to the body 10 than the mount surface 31 in the optical axis direction Z. Accordingly, the lens 2B for mirrorless camera having the flange back shorter than the flange back unique to the body 10 can be mounted on the body 10 through the adapter 3B. Further, even when the protruding component such as the tripod fixing member or the motorized zoom mechanism 62 is added to the lens 2B, the lens 2B can be mounted on the body 10 through the adapter 3B without the interference between the rotation ring 23 of the body mount 20 and the protruding component of the lens 2B. Accordingly, a user of the lens 2, which has been used in the video industry, is able to easily use the lens 2B, which has been used in the photography industry. Accordingly, by lowering barriers of classification of cinema photography, broadcast, consumer-oriented still image photography, and the like, a user easily obtains new experience opportunities. As a result, it is possible to increase video representability.

### Modification Example 3

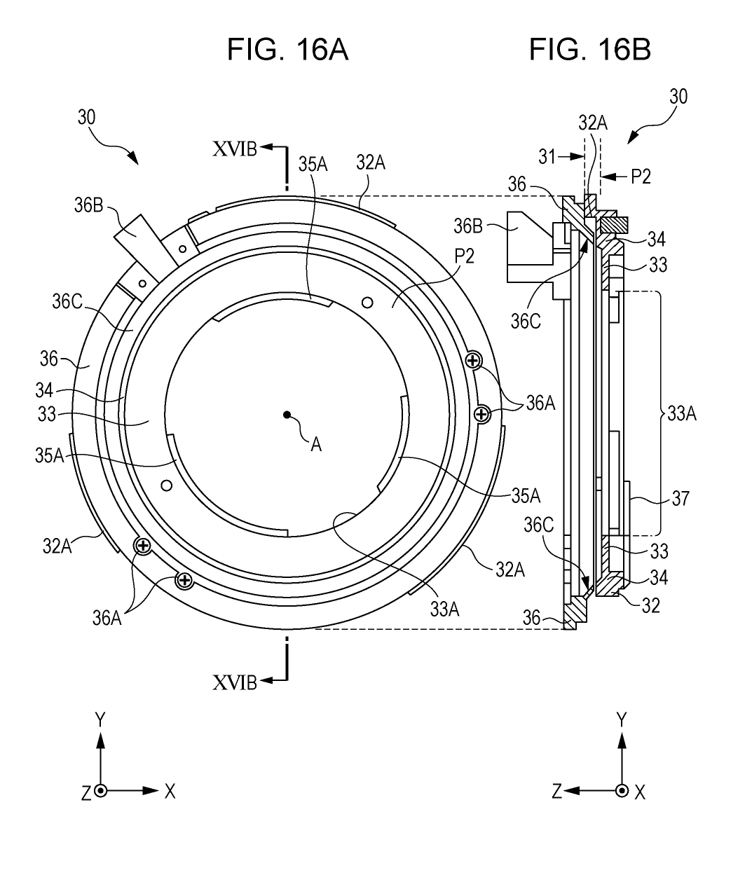

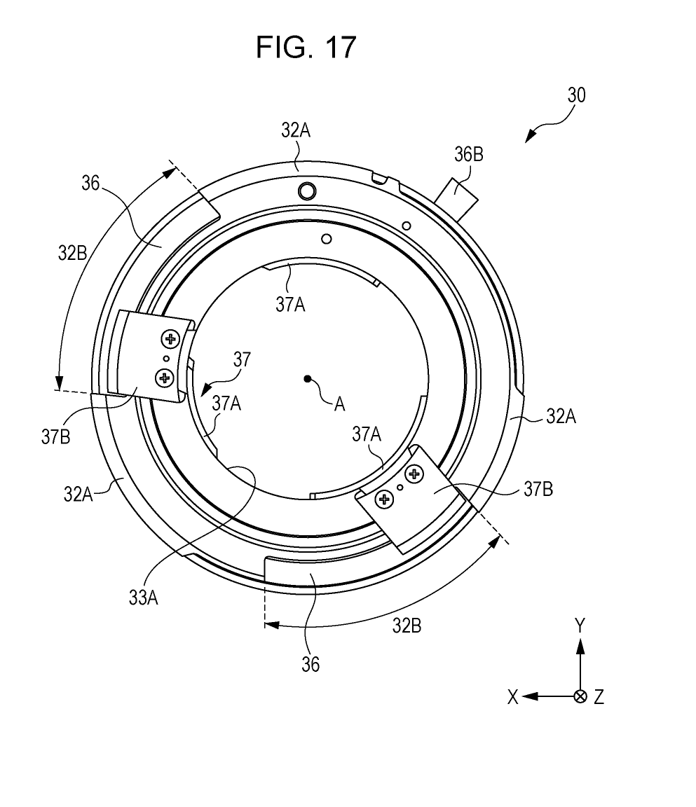

FIG. 16A shows a configuration of the adapter 3B according to Modification Example 3, as viewed from the front side. FIG. 16B shows a cross-sectional configuration of the adapter 3B taken along the line XVIB-XVIB of FIG. 16A. FIG. 17 shows a configuration of the adapter 3B shown in FIGS. 16A and 16B viewed from the rear side. The adapter 3B of the present modification example is different from the adapter 3B of Modification Example 2 in that the spigot method is employed as the method of mounting the lens 2B. Accordingly, the corresponding components will be referenced by the same numerals and signs.

The adapter 3B is to convert the body mount 20 of the imaging apparatus 1 into a mount on which a lens for a mirrorless camera can be mounted, and to fix the lens 2B onto the body mount 20 in the spigot method. The adapter 3B has, for example, as shown in FIGS. 16A and 16B, the outer circumferential portion 32, the inner circumference portion 33, the intermediate portion 34, a fastening section 36, and a spigot mechanism 37. An opening 33A having a circular shape is formed on the inner circumference side of the adapter 3B. An aperture of the adapter 3B is smaller than an aperture of the body mount 20.

The outer circumferential portion 32 is a portion mounted on the first reference surface P1 of the body mount 20, and has a mount surface 31. The mount surface 31 is a surface that is in contact with a first reference surface P1 in a state where the surface is mounted on the first reference surface P1 of the body mount 20. The outer circumferential portion 32 has outer blades 32A that are provided at three locations in the circumferential direction and are for mounting on the body mount 20.

The fastening section 36 fastens and fixes or separates the lens 2B and adapter 3B by rotating around the optical axis A. The fastening section 36 is fixed on the front side of the outer circumferential portion 32 in the optical axis direction Z by screws 36A. A mount-release lever 36B is provided on the fastening section 36. As shown in FIG. 16A, the mount-release lever 36B fastens the lens 2B onto the adapter 3B, or releases the lens 2B from the adapter 3B. The mount-release lever 36B is provided on the upper left side of the fastening section 35. Further, it is preferable that the fastening section 36 have an inclined surface 36C at the boundary between the fastening section 36 and the inner circumference portion 33. Since the fastening section 36 has the inclined surface 36C, the fastening section 36 can be adapted to various lens shapes. In addition, by providing the inclined surface 36C, extra space is formed around the mount-release lever 36B. Thus, it becomes easy for a user to operate the mount-release lever 36B.

The inner circumferential portion 33 is formed in a concentric shape inside the outer circumferential portion 32, and has a second reference surface P2. It is preferable that the second reference surface P2 be positioned to be closer to the body 10 side than the mount surface 31 in the optical axis direction Z. With such a configuration, the lens 2B having the flange back shorter than the flange back unique to the body 10 can be mounted on the body mount 20 through the adapter 3B.

The spigot mechanism 37 is provided on the rear side of the inner circumference portion 33 in the optical axis direction Z, and has inner blades 37A at three locations in the circumferential direction. The spigot mechanism 37 is fixed onto the fastening section 36 through a connection portion 37B, and is rotatable around the optical axis A in accordance with the rotation of the fastening section 36. The connection portion 37B is provided in a guide groove 32B having a shape in which the circumference of the outer circumferential portion 32 is partially cut off. Accordingly, movable ranges of the connection portion 37B and the fastening section 36 are defined by the guide groove 32B.

The intermediate portion 34 is a portion that connects the inner circumference portion 33 with the fastening section 36 and the outer circumferential portion 32 in the optical axis direction Z. The intermediate portion 34 may have the level difference and the inclined surface 34A, in a manner similar to that of Modification Example 2.

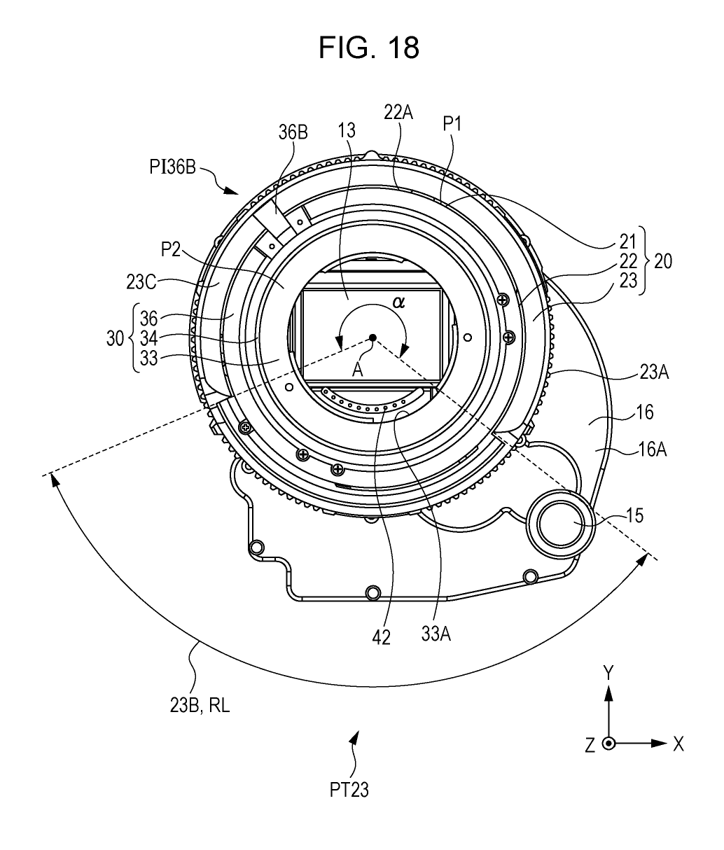

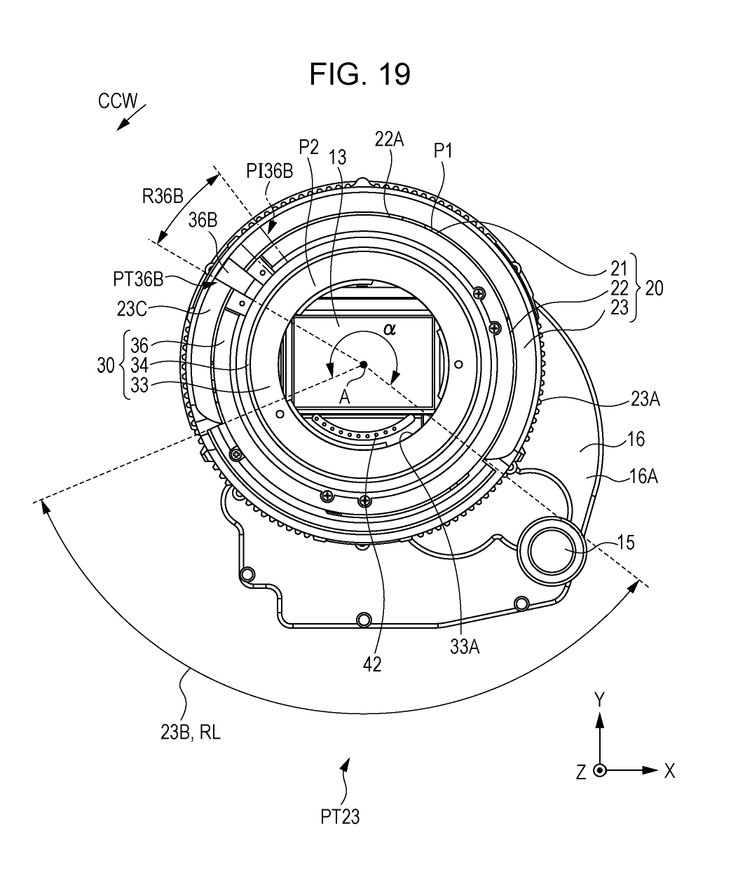

FIGS. 18 and 19 show a configuration of the body mount 20 in a state where the adapter 30 is mounted on the body mount 20 shown in FIG. 12, as viewed from the front side. FIG. 18 shows a situation where the mount-release lever 36B is at an initial position PI36B, and FIG. 19 shows a situation where the mount-release lever 36B is at a fastening position PT36B.

In a manner similar to that of Modification Example 2, in the state where the adapter 30 is mounted on the first reference surface P1, the first body contact point 41 is concealed in the adapter 30. Thus, it is preferable that the second body contact point 42 be exposed through the opening 33A on the inner circumference side of the adapter 30. Thereby, the lens 2B and the second body contact point 42, which is exposed through the opening 33A of the adapter 30, can be easily connected. Further, by concealing the first body contact point 41 in the adapter 30, it is possible to easily and visually recognize that it is difficult for the lens 2B to be mounted. As a result, it becomes easy to perform lens mounting.

It is preferable that a movable range R36B of the mount-release lever 36B of the adapter 30 be provided in a range of the standing wall portion 23C other than the notch portion 23B of the rotation ring 23. Thereby, it is possible to operate the mount-release lever 36B without interference between the mount-release lever 36B and the protruding component which protrudes downward from the lens 2B.

Further, it is preferable that the movable range R36B of the mount-release lever 36B of the adapter 30 be positioned on the obliquely upper side of the circumference centered on the optical axis A, for example, on the upper left side or the upper right side thereof, as the body mount 20 is viewed from the front side. When the mount-release lever 36B is disposed on the upper side of the circumference centered on the optical axis A, a user tends to be confused whether to turn the mount-release lever 36 clockwise or counterclockwise in order to perform the fastening. In contrast, when the mount-release lever 36B is positioned on the obliquely upper side, a user tends to visually and intuitively recognize that fastening is performed by pulling down the mount-release lever 36B. Further, in most cases, an assistant cameraman who assists a main cameraman stands beside the imaging apparatus 1 and operates the mount-release lever 36B. Accordingly, since the mount-release lever 36B is disposed on the obliquely upper side, it becomes easy for an assistant cameraman to operate the mount-release lever 36B. Accordingly, a working efficiency improves.

Specifically, it is preferable that the initial position PI36B of the mount-release lever 36B shown in FIG. 18 be on the upper left side of the circumference centered on the optical axis A as the body mount 20 is viewed from the front side. In addition, it is preferable that the fastening position PT36B of the mount-release lever 36B shown in FIG. 19 be a position which is set through counterclockwise rotation CCW from the initial position PI36B. In addition, depending on the direction of rotation for the fastening of the fastening section 36, the initial position PI36B of the mount-release lever 36B may be set on the upper right side, and the fastening position PT36B of the mount-release lever 36B may be a position which is set through clockwise rotation from the initial position PI36B.

In the imaging system 100, for example, in the following manner, the adapter 30 and the lens 2B are mounted on the imaging apparatus 1.

First, in a manner similar to Modification Example 2, the adapter 30 is mounted on and fixed onto the first reference surface P1 of the body mount 20.

Thereafter, the blades (not shown in the drawing) of the lens 2B at the rear end portion are inserted between inner blades 37A of the spigot mechanism 37 of the adapter 30, and the mount-release lever 36B is shifted from the initial position PI36B shown in FIG. 18 to the fastening position PT36B shown in FIG. 19. Thereby, the lens 2B is mounted on or fixed onto the second reference surface P2 of the adapter 30.

At this time, it is preferable that a rotation direction of tightening the rotation ring 23 in the body mount 20 be opposite to a rotation direction of releasing the lens 2B from the second reference surface P2 by rotating the fastening section 36 in the adapter 30, when the optical axis A is set as the center thereof. In such a manner, when a user turns the rotation ring 23 of the body mount 20 in a loosening direction, in contrast, in the lens 2B, the rotation direction is set as a direction of enhancing the fastening. Accordingly, when a user wants to remove the lens 2B from the adapter 30, the user may wrongly turn the rotation ring 23 of the body mount 20 instead of the mount-release lever 36B in the direction of clockwise rotation CW. Even in this case, there is no problem. In contrast, when a user wants to fasten the lens 2B onto the adapter 30, the user may wrongly turn the rotation ring 23 of the body mount 20 instead of the mount-release lever 36B in the direction of counterclockwise rotation CCW. Even in this case, there is no problem. In such a manner, it is possible to avoid that the adapter 30 or the lens 2B is accidentally separated from the body mount 20, and it is possible to improve stability and safety of lens mounting.

As described above, in the present modification example, in addition to the effects of the embodiment and Modification Example 2, the spigot method is employed as the method of fastening the adapter 30 and the lens 2B. Therefore, it is possible to further reliably fasten the lens 2B onto the adapter 30. Further, since the body mount 20 also employs the spigot method, it is possible to reduce rattling which may be caused by using the adapter 30.

### Modification Examples 4 to 7

In the description of Modification Examples 2 and 3, as the body mount 20 is viewed from the front side, the first body contact point 41 is provided on the left side of the circumference centered on the optical axis A, and the second body contact point 42 is provided on the lower side of the circumference centered on the optical axis A. However, arrangement of the first body contact point 41 and the second body contact point 42 is not limited to the examples of Modification Examples 2 and 3, and may be modified into various forms like the following Modification Examples 4 to 7. It is needless to say that the modification examples of the arrangement of the first body contact point 41 and the second body contact point 42 are not limited to the following Modification Examples 4 to 7.

### Modification Example 4

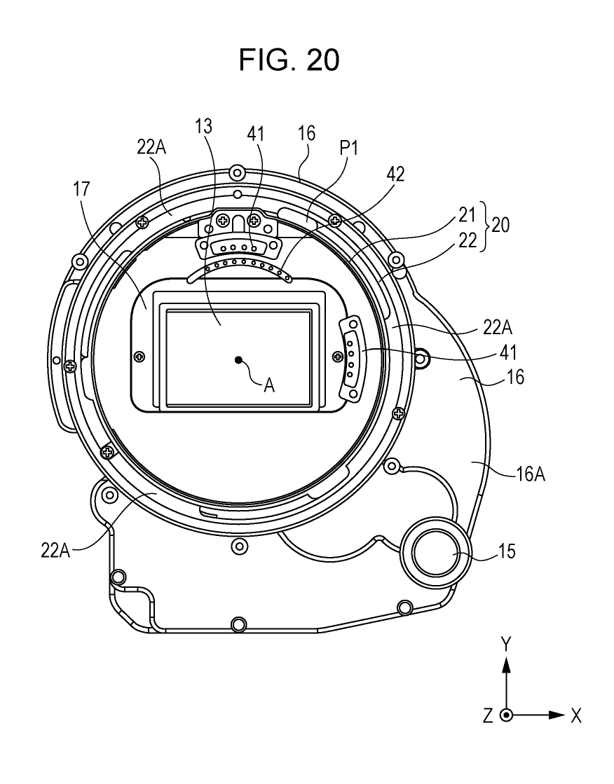

For example, as shown in FIG. 20, as the body mount 20 is viewed from the front side, the first body contact point 41 may be disposed on the upper side and the right side of the circumference centered on the optical axis A, and the second body contact point 42 may be disposed on the upper side of the circumference centered on the optical axis A.

### Modification Example 5

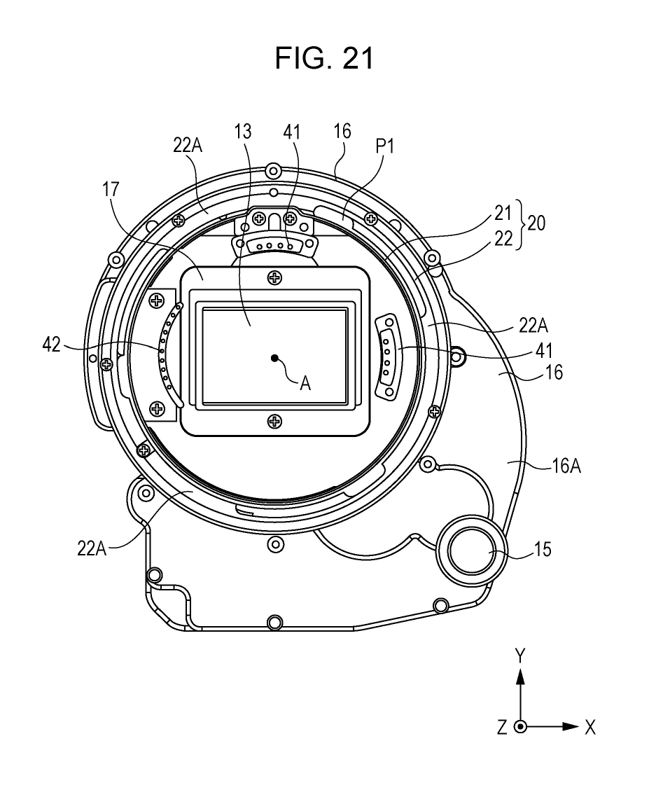

Further, for example, as shown in FIG. 21, as the body mount 20 is viewed from the front side, the first body contact point 41 may be disposed on the upper side and the right side of the circumference centered on the optical axis A, and the second body contact point 42 may be disposed on the left side of the circumference centered on the optical axis A.

### Modification Example 6

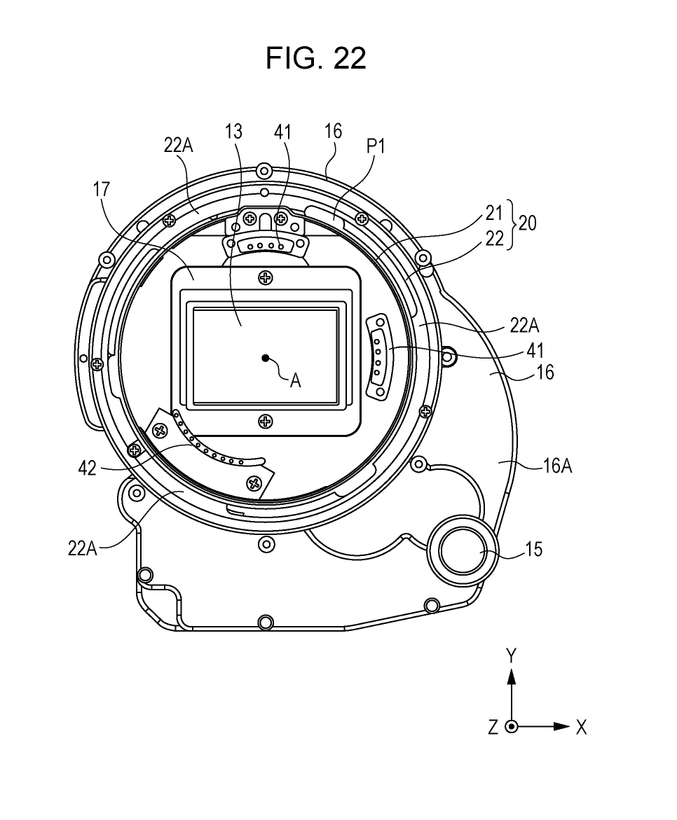

Furthermore, for example, as shown in FIG. 22, as the body mount 20 is viewed from the front side, the first body contact point 41 may be disposed on the upper side and the right side of the circumference centered on the optical axis A, and the second body contact point 42 may be disposed on the lower left side of the circumference centered on the optical axis A.

### Modification Example 7

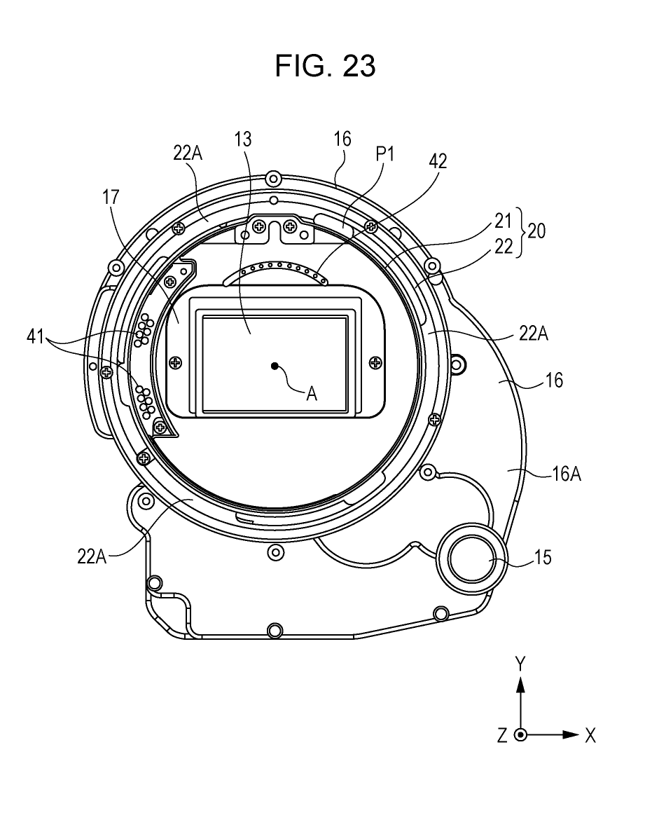

In addition, for example, as shown in FIG. 23, as the body mount 20 is viewed from the front side, the first body contact point 41 may be disposed on the left side of the circumference centered on the optical axis A, and the second body contact point 42 may be disposed on the upper side of the circumference centered on the optical axis A.

The present disclosure has hitherto been described with reference to the embodiment, but the present disclosure is not limited to the embodiment, and may be modified into various forms.

For example, in the description of the embodiment, when the rotation ring 23 is at the fastening position PT23, the notch portion 23B and the operation dial 15 form the gap G which gives access to the flange back adjustment knob 55 from the side surface of the body mount 20. However, the present disclosure is not limited to the operation dial 15, and it is preferable that it be the same for a different operation section which is provided in a region on the outer circumference side of the body mount 20 as viewed from the front side of the body 10. That is, when the rotation ring 23 is at the fastening position PT23, the notch portion 23B and the different operation section form the gap G which gives access to the protruding component from the side surface of the body mount 20.

Further, the imaging apparatus 1 according to the present disclosure is not limited to a camera for cinema photography described in the embodiment, and may be a different camera such as a single-lens reflex camera having a spigot-type body mount.

Furthermore, for example, the shapes, the dimensions, the materials, and the like of the constituent elements described in the above embodiment are not limited, and other shapes, dimensions, and materials may be used.

In addition, for example, in the embodiment, the configurations of the imaging system 100, the imaging apparatus 1, the lens 2, the adapter 3, and the like have been described in detail, but it is not necessary to provide all the elements, and other elements may be further provided.

It should be noted that the effects described in the present specification are just examples and are not limited to this. Further, the present technology may have other effects.

The present technology may adopt the following configurations.

(1)
An imaging apparatus including:
a body; and
a body mount of a spigot type that is provided on the body,
in which the body mount includes
a fixing ring, and
a rotation ring that is rotatable around an optical axis relative to the fixing ring and has a notch portion on a part of a circumference.
(2)
The imaging apparatus according to (1), in which the rotation ring is rotatable between an initial position and a fastening position, and has an open region in which an area of the notch portion at the initial position overlaps with an area of the notch portion at the fastening position.
(3)
The imaging apparatus according to (2), in which the open region is provided in a region which is on a side lower than the optical axis of the rotation ring.
(4)
The imaging apparatus according to any one of (1) to (3), in which a central angle centered on the optical axis of the notch portion is equal to or less than 180°.
(5)
The imaging apparatus according to any one of (1) to (4),
in which the body mount further includes a holding ring that has a blade which pinches a target object between the fixing ring and the blade,
in which the rotation ring is rotatable together with the holding ring, and
in which a height of the notch portion in a direction of the optical axis is equal or approximately equal to a height of the holding ring in the direction of the optical axis.
(6)
The imaging apparatus according to any one of (1) to (5),
in which the body has a body contact point on an inner circumference side of the body mount,
in which the rotation ring is rotatable between an initial position and a fastening position, and
in which an area of the notch portion at the initial position and at least a part of the body contact point are different in positions in a rotation direction with respect to the optical direction.
(7)
The imaging apparatus according to any one of (1) to (6),
in which the body has a body contact point on an inner circumference side of the body mount,
in which the rotation ring is rotatable between an initial position and a fastening position, and
in which an area of the notch portion at the fastening position and at least a part of the body contact point are different in positions in a rotation direction with respect to the optical direction.
(8)
An imaging system including:
an imaging apparatus; and
a lens which is mountable on the imaging apparatus,
in which the imaging apparatus includes
a body, and
a body mount of a spigot type that is provided on the body,
in which the body mount includes
a fixing ring, and
a rotation ring that is rotatable around an optical axis relative to the fixing ring and has a notch portion on a part of a circumference.
(9)
The imaging system according to (8), in which the rotation ring is rotatable between an initial position and a fastening position, and has an open region in which an area of the notch portion at the initial position overlaps with an area of the notch portion at the fastening position.
(10)
The imaging system according to (9),
in which the lens has a lens main body and a protruding component that protrudes outward from the lens main body in a diameter direction with respect to the optical axis, and
in which the protruding component is provided in a region corresponding to the open region on the circumference centered on the optical axis.
The imaging system according to (9) or (10), further including an adapter that combines the imaging apparatus with the lens,
in which the adapter has an adapter main body and a protruding component that protrudes outward from the adapter main body in a diameter direction with respect to the optical axis, and
in which the protruding component is provided in a region corresponding to the open region on the circumference centered on the optical axis.
(12)
The imaging system according to (11),
in which the body has an operation section in a region of the body mount on an outer circumference side as viewed from the front,
in which the rotation ring has a standing wall portion other than the notch portion, and
in which when the rotation ring is at the fastening position, the notch portion and the operation section form a gap which gives access to the protruding component from a side surface of the body mount.
(13)
The imaging system according to (11) or (12),
in which the fixing ring has a first reference surface, and
in which the adapter has a mount surface, through which the adapter is mounted on the first reference surface of the fixing ring, and a second reference surface on which the lens is mounted, and the second reference surface is positioned to be closer to the body than the mount surface in a direction of the optical axis.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging apparatus including:
a body; and
a body mount of a spigot type that is provided on the body,
wherein the body mount includes
a fixing ring, and
a rotation ring that is rotatable around an optical axis relative to the fixing ring and has a notch portion on a part of a circumference.

2. The imaging apparatus according to claim 1, wherein the rotation ring is rotatable between an initial position and a fastening position, and has an open region in which an area of the notch portion at the initial position overlaps with an area of the notch portion at the fastening position.

3. The imaging apparatus according to claim 2, wherein the open region is provided in a region which is on a side lower than the optical axis of the rotation ring.

4. The imaging apparatus according to claim 1, wherein a central angle centered on the optical axis of the notch portion is equal to or less than 180°.

5. The imaging apparatus according to claim 1,
wherein the body mount further includes a holding ring that has a blade which pinches a target object between the fixing ring and the blade,
wherein the rotation ring is rotatable together with the holding ring, and
wherein a height of the notch portion in a direction of the optical axis is equal or approximately equal to a height of the holding ring in the direction of the optical axis.

6. The imaging apparatus according to claim 1,
wherein the body has a body contact point on an inner circumference side of the body mount,
wherein the rotation ring is rotatable between an initial position and a fastening position, and
wherein an area of the notch portion at the initial position and at least a part of the body contact point are different in positions in a rotation direction with respect to the optical direction.

7. The imaging apparatus according to claim 1,
wherein the body has a body contact point on an inner circumference side of the body mount,
wherein the rotation ring is rotatable between an initial position and a fastening position, and
wherein an area of the notch portion at the fastening position and at least a part of the body contact point are different in positions in a rotation direction with respect to the optical direction.

8. An imaging system including:
an imaging apparatus; and
a lens which is mountable on the imaging apparatus,
wherein the imaging apparatus includes
a body, and
a body mount of a spigot type that is provided on the body,
wherein the body mount includes
a fixing ring, and
a rotation ring that is rotatable around an optical axis relative to the fixing ring and has a notch portion on a part of a circumference.

9. The imaging system according to claim 8, wherein the rotation ring is rotatable between an initial position and a fastening position, and has an open region in which an area of the notch portion at the initial position overlaps with an area of the notch portion at the fastening position.

10. The imaging system according to claim 9,
wherein the lens has a lens main body and a protruding component that protrudes outward from the lens main body in a diameter direction with respect to the optical axis, and
wherein the protruding component is provided in a region corresponding to the open region on the circumference centered on the optical axis.

11. The imaging system according to claim 9, further including an adapter that combines the imaging apparatus with the lens,
wherein the adapter has an adapter main body and a protruding component that protrudes outward from the adapter main body in a diameter direction with respect to the optical axis, and
wherein the protruding component is provided in a region corresponding to the open region on the circumference centered on the optical axis.

12. The imaging system according to claim 11,
wherein the body has an operation section in a region of the body mount on an outer circumference side as viewed from the front,
wherein the rotation ring has a standing wall portion other than the notch portion, and
wherein when the rotation ring is at the fastening position, the notch portion and the operation section form a gap which gives access to the protruding component from a side surface of the body mount.

13. The imaging system according to claim 11,
wherein the fixing ring has a first reference surface, and
wherein the adapter has a mount surface, through which the adapter is mounted on the first reference surface of the fixing ring, and a second reference surface on which the lens is mounted, and the second reference surface is positioned to be closer to the body than the mount surface in a direction of the optical axis.
